(19) United States
(12) Patent Application Publication
(10) Pub. No.: US 2026/0351849 A1
(43) Pub. Date: Nov. 5, 2026

(54) INTELLIGENT REFLECTING SURFACE AND REFLECTING DEVICE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 19/710,395

(22) Filed: Jun. 17, 2026

Related U.S. Application Data
(63) Continuation of application No. PCT/JP2024/038699, filed on Oct. 30, 2024.

(30) Foreign Application Priority Data
Dec. 28, 2023 (JP) 2023-223124

(51) Int. Cl. H01Q 3/34; H01Q 21/06

(52) U.S. Cl. CPC H01Q 3/34; H01Q 21/065

(57) ABSTRACT

An intelligent reflecting surface includes a patch electrode over a first substrate, a counter electrode over a second substrate different from the first substrate, a liquid crystal layer between the patch electrode and the counter electrode, a reflecting antenna region in which the patch electrode and the counter electrode overlap each other in a plan view, and a peripheral region in which only the counter electrode is provided, surrounding the reflecting antenna region in the plan view. Each of the patch electrode and the counter electrode includes a plurality of opening portions.

### CROSS-REFERENCE TO RELATED APPLICATIONS

This application is a Continuation of International Patent Application No. PCT/JP2024/038699, filed on Oct. 30, 2024, which claims the benefit of priority to Japanese Patent Application No. 2023-223124, filed on Dec. 28, 2023, the entire contents of each are incorporated herein by reference.

### FIELD

An embodiment of the present invention relates to an intelligent reflecting surface capable of controlling the reflection direction of an incident radio wave. Further, an embodiment of the present invention relates to a reflecting device in which a plurality of intelligent reflecting surfaces are combined.

### BACKGROUND

A phased array antenna device (hereinafter, referred to as a “intelligent reflecting surface”) has a plurality of antenna elements arranged in a plane, and controls the directionality of a radio wave by adjusting the amplitude and phase of a high-frequency signal applied to each of the plurality of antenna elements while the phased array antenna device is fixed. The phased array antenna device requires a phase shifter. The phased array antenna device including a phase shifter that uses a change in dielectric constant due to the alignment state of a liquid crystal is disclosed (for example, see Japanese laid-open patent application No. H11-103201).

The antenna element of the phased array antenna device in Japanese laid-open patent application No. H11-103201 has a plurality of strip wirings, a planar electrode facing the plurality of strip wirings, and a liquid crystal layer between the plurality of strip wirings and the planar electrode. Different voltages are applied to the plurality of strip wirings in the plurality of antenna elements. The phase can be changed by adjusting the dielectric constant of the liquid crystal layer for each antenna element and superposing the reflected waves. In this way, the reflecting direction of the radio wave can be set in any direction.

### SUMMARY

An intelligent reflecting surface according to an embodiment of the present invention includes a patch electrode over a first substrate, a counter electrode over a second substrate different from the first substrate, a liquid crystal layer between the patch electrode and the counter electrode, a reflecting antenna region in which the patch electrode and the counter electrode overlap each other in a plan view, and a peripheral region in which only the counter electrode is provided, surrounding the reflecting antenna region in the plan view. Each of the patch electrode and the counter electrode includes a plurality of opening portions.

A reflecting device according to an embodiment of the present invention includes a first intelligent reflecting surface and a second intelligent reflecting surface. Each of the first intelligent reflecting surface and the second intelligent reflecting surface includes a patch electrode over a first substrate, a counter electrode over a second substrate different from the first substrate, a liquid crystal layer between the patch electrode and the counter electrode, a reflecting antenna region in which the patch electrode and the counter electrode overlap each other in a plan view, and a peripheral region in which only the counter electrode is provided, surrounding the reflecting antenna region in the plan view. Each of the patch electrode and the counter electrode includes a plurality of opening portions. The peripheral region in the first intelligent surface and the peripheral region in the second intelligent surface are in contact with each other.

### BRIEF DESCRIPTION OF DRAWINGS

FIG. 1A is a schematic plan view showing an overview of the configuration of an intelligent reflecting surface according to an embodiment of the present invention.

FIG. 1B is a schematic plan view showing an overview of the configuration of an intelligent reflecting surface according to an embodiment of the present invention.

FIG. 2 is a schematic cross-sectional view showing a configuration of a reflecting antenna cell of an intelligent reflecting surface according to an embodiment of the present invention and a reflection direction of a radio wave by the reflecting antenna cell.

FIG. 3 is a schematic plan view showing configurations of a reflecting antenna region and a peripheral region of an intelligent reflecting surface according to an embodiment of the present invention.

FIG. 4A is a schematic plan view showing configurations of a reflecting antenna region and a peripheral region of an intelligent reflecting surface according to an embodiment of the present invention.

FIG. 4B is a schematic plan view showing configurations of a reflecting antenna region and a peripheral region of an intelligent reflecting surface according to an embodiment of the present invention.

FIG. 5 is a schematic plan view showing a configuration of a reflecting antenna region of an intelligent reflecting surface according to an embodiment of the present invention.

FIG. 6 is a schematic cross-sectional view showing a configuration of a reflecting antenna region of an intelligent reflecting surface according to an embodiment of the present invention.

FIG. 7 is a schematic plan view showing a configuration of a peripheral region of an intelligent reflecting surface according to an embodiment of the present invention.

FIG. 8 is a schematic cross-sectional view showing a configuration of a peripheral region of an intelligent reflecting surface according to an embodiment of the present invention.

### DESCRIPTION OF EMBODIMENTS

An intelligent reflecting surface can simplify a radio base station. However, there is a problem in that the installation of the intelligent reflecting surface spoils the landscape. Therefore, a transparent intelligent reflecting surface is in demand for use in a fifth-generation mobile communication system (5G). The transparent intelligent reflecting surface can be made using a liquid crystal. Further, it is possible to manufacture a large-area transparent reflecting device by combining and arranging a plurality of transparent intelligent reflecting surfaces. However, a transparent reflecting device has a problem in that a boundary between two adjacent intelligent reflecting surfaces is noticeable, and visibility at the boundary between intelligent reflecting surfaces is poor.

In view of the above problem, an embodiment of the present invention can provide a transparent intelligent reflecting surface that improves visibility at a boundary between the intelligent reflecting surfaces when a plurality of intelligent reflecting surfaces is combined and arranged. Further, an embodiment of the present invention can provide a reflecting device in which a plurality of transparent intelligent reflecting surfaces are combined and arranged, and visibility at a boundary between intelligent reflecting surfaces is improved.

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each component are a convenience sign used to distinguish them and have no further meaning except as otherwise explained.

As used in the present specification, where a member or region is “on” (or “under”) another member or region, this includes cases where it is not only directly on (or just under) the other member or region but also above (or below) the other member or region, unless otherwise specified. That is, it includes the case where another component is included in between above (or below) other members or regions.

In the present specification, “substantially identical” means that the two components are different in size but identical in shape, the difference in area between the two components is within ±5%, or the difference in aperture ratio between the two components is within 5%.

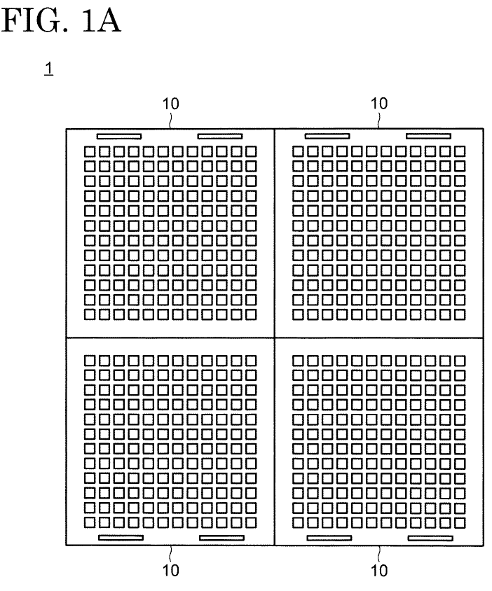

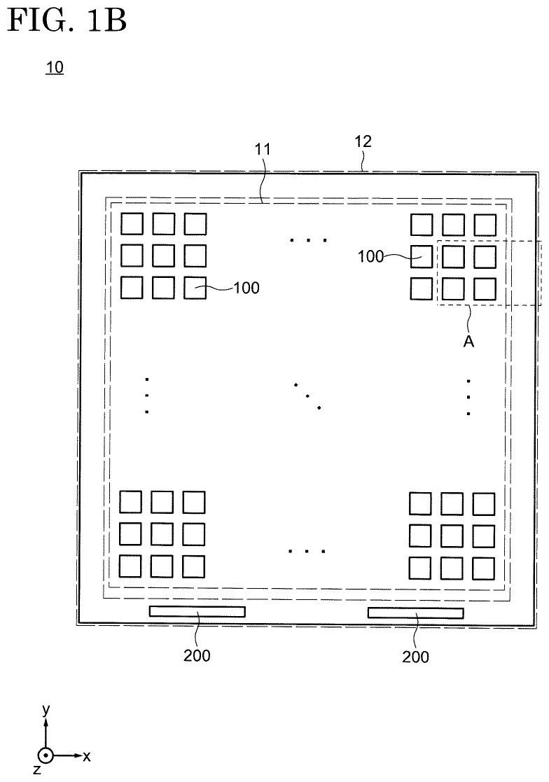

An embodiment of a reflecting device 1 or an intelligent reflecting surface 10 is described with reference to FIGS. 1A to 3.

### 1. Configuration of Reflecting Device 1

FIG. 1A is a schematic plan view showing an overview of the configuration of the reflecting device 1 according to an embodiment of the present invention.

As shown in FIG. 1A, the reflecting device 1 includes a plurality of intelligent reflecting surfaces 10. Two intelligent reflecting surfaces 10 are arranged so that their edge surfaces are in contact with each other. Therefore, one intelligent reflecting surface 10 includes at least one edge surface that is in contact with the edge surface of another intelligent reflecting surface 10. Although FIG. 1A shows four intelligent reflecting surfaces 10, the number of intelligent reflecting surfaces 10 in the reflecting device 1 is not limited to four. The number of intelligent reflecting surfaces 10 in the reflecting device 1 can be two or more. Further, although the planar shape of the intelligent reflecting surface 10 shown in FIG. 1A is rectangular, the planar shape of the intelligent reflecting surface 10 in the intelligent reflecting surface 1 is not limited thereto. The planar shape of the intelligent reflecting surface 10 in the reflecting device 1 may be, for example, hexagonal. In addition, it is preferable that the intelligent reflecting surfaces 10 have a planar shape that does not generate gaps between the intelligent reflecting surfaces 10 when the plurality of intelligent reflecting surfaces 10 are combined and arranged.

### 2. Configuration of Intelligent Reflecting Surface 10

FIG. 1B is a schematic plan view showing an overview of a configuration of an intelligent reflecting surface 10 according to an embodiment of the present invention.

As shown in FIG. 1B, the intelligent reflecting surface 10 includes a reflecting antenna region 11 and a peripheral region 12. The reflecting antenna region 11 is provided in the center of the intelligent reflecting surface 10, and the peripheral region 12 surrounds the reflecting antenna region 11 and is provided in the peripheral portion of the intelligent reflecting surface 10. The reflecting antenna region 11 is provided with a plurality of reflecting antenna cells 100. The plurality of reflecting antenna cells 100 are arranged in a matrix in an x-axis direction and a y-axis direction. However, the arrangement configuration of the plurality of reflecting antenna cells 100 is not limited thereto. The peripheral region 12 is provided with a drive circuit 200 that generates control signals to control each of the plurality of reflecting antenna cells 100. Further, wirings are also provided to electrically connect the reflecting antenna cells 100 and the drive circuit 200. Although not shown in the figures, the peripheral region 12 may be provided with terminals for supplying signals or power from the outside.

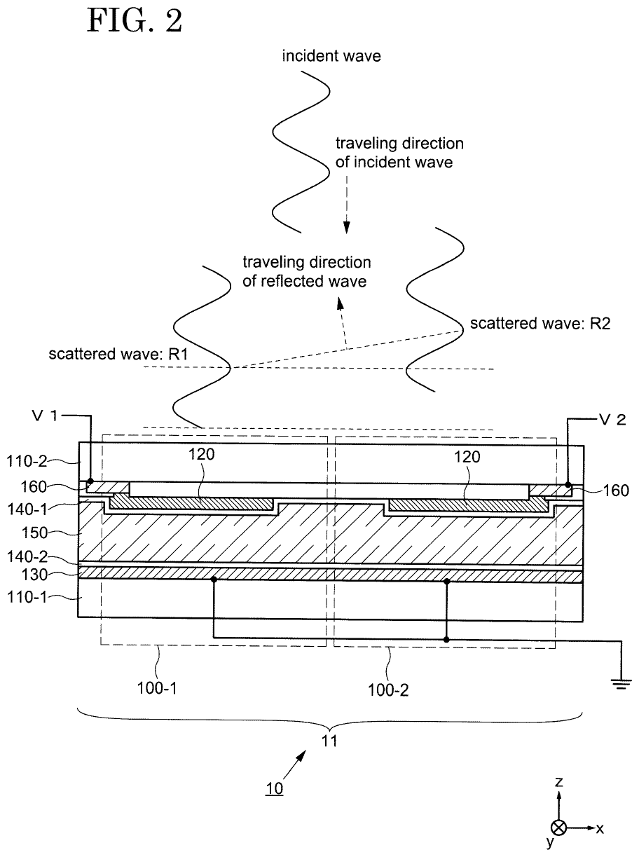

Here, a configuration and a function of the reflecting antenna cell 100 are described with reference to FIG. 2.

FIG. 2 is a schematic cross-sectional view showing the configuration of the reflecting antenna cell 100 of the intelligent reflecting surface 10 according to an embodiment of the present invention and a reflection direction of a radio wave by the reflecting antenna cell 100. In FIG. 2, two adjacent reflecting antenna cells 100 are shown as a first reflecting antenna cell 100-1 and a second reflecting antenna cell 100-2.

Each of the first reflecting antenna cell 100-1 and the second reflecting antenna cell 100-2 includes a patch electrode 120 provided on a first substrate 110-1 and a counter electrode 130 provided on a second substrate 110-2. The patch electrode 120 of the first reflecting antenna cell 100-1 and the patch electrode 120 of the second reflecting antenna cell 100-2 are not electrically connected to each other. On the other hand, the counter electrode 130 is provided in common to both the first reflecting antenna cell 100-1 and the second reflecting antenna cell 100-2. A first alignment film 140-1 is provided on the patch electrode 120. A second alignment film 140-2 is provided on the counter electrode 130. The first substrate 110-1 and the second substrate 110-2 are arranged so that the patch electrode 120 and the counter electrode 130 face each other, and a liquid crystal layer 150 is provided between the first alignment film 140-1 and the second alignment film 140-2.

Glass, quartz, or resin can be used for each of the first substrate 110-1 and the second substrate 110-2.

A metal material can be used for each of the patch electrode 120 and the counter electrode 130. For example, the metal material may be molybdenum (Mo), tungsten (W), titanium (Ti), aluminum (Al), or copper (Cu), or an alloy thereof. The patch electrode 120 and the counter electrode 130 may each have a single layer structure or a laminated structure.

Polyimide resin or the like can be used for each of the first alignment film 140-1 and the second alignment film 140-2. An alignment treatment using methods such as rubbing or photo-alignment is performed on the first alignment film 140-1 and the second alignment film 140-2.

The liquid crystal layer 150 contains a liquid crystal material having dielectric anisotropy. For example, a nematic liquid crystal or a cholesteric liquid crystal containing liquid crystal molecules capable of a twist alignment can be used as the liquid crystal material of the liquid crystal layer 150. Further, it is preferable that the liquid crystal layer 150 contains a chiral agent to stabilize the twist orientation of the liquid crystal molecules.

The initial alignment (alignment state when no voltage is applied) of the liquid crystal molecules in the liquid crystal layer 150 is controlled by the first alignment film 140-1 and the second alignment film 140-2 on which the alignment treatment is performed. When a voltage is applied to the patch electrode 120 and a potential difference is generated between the patch electrode 120 and the counter electrode 130, the alignment state of the liquid crystal molecules in the liquid crystal layer 150 changes, and the dielectric constant of the liquid crystal layer 150 also changes. Although details are described layer, the intelligent reflecting surface 10 uses the change in the dielectric constant of the liquid crystal layer 150 to control the phase of a reflected wave.

In the case where the liquid crystal molecules have positive dielectric anisotropy, the dielectric constant is greater when a voltage is applied than when no voltage is applied. In the case where the liquid crystal molecules have negative dielectric anisotropy, the dielectric constant is smaller when a voltage is applied than when no voltage is applied. The liquid crystal layer 150 formed of the liquid crystal having dielectric anisotropy can also be considered as a variable dielectric layer. The reflecting antenna cell 100 can control the phase of the radio wave scattered by the counter electrode 130 to be delayed (or not delayed) by using the dielectric anisotropy of the liquid crystal layer 150.

As described above, the basic configurations of the first reflecting antenna cell 100-1 and the second reflecting antenna cell 100-2 are the same. That is, each of the plurality of reflecting antenna cells 100 has the basic configuration described above. On the other hand, each of the plurality of reflecting antenna cells 100 is electrically connected to a switching element 160. Specifically, the switching element 160 is electrically connected to the patch electrode 120, and the voltage applied to the patch electrode 120 changes by controlling the switching element 160.

As shown in FIG. 2, radio waves are incident on the intelligent reflecting surface 10 parallel to the normal direction of the surface of the first substrate 110-1 (see “traveling direction of incident wave” in FIG. 2). Here, it is considered that a first voltage V1 is applied to the patch electrode 120 of the first reflecting antenna cell 100-1, and a second voltage V2, which is different from the first voltage V1, is applied to the patch electrode 120 of the second reflecting antenna cell 100-2. When the radio wave with the same phase is incident on the first reflecting antenna cell 100-1 and the second reflecting antenna cell 100-2, scattered waves with different phases are generated in the first reflecting antenna cell 100-1 and the second reflecting antenna cell 100-2 because the dielectric constants of the liquid crystal layer 150 are different in the first reflecting antenna cell 100-1 and the second reflecting antenna cell 100-2. For example, as shown in FIG. 2, the phase of the scattered wave R2 scattered by the second reflecting antenna cell 100-2 leads the phase of the scattered wave R1 scattered by the first reflecting antenna cell 100-1. In this case, the radio wave reflected in the reflecting antenna region 11 travels in a direction different from the normal direction of the surface of the first substrate 110-1 (see “traveling direction of reflected wave” in FIG. 2). Although FIG. 2 shows two adjacent reflecting antenna cells 100, the intelligent reflecting surface 10 can control the plurality of reflecting antenna cells 100 arranged in a matrix independently. Therefore, the intelligent reflecting surface 10 can control the reflecting direction of the radio wave to any desired direction.

The frequency bands to which the intelligent reflecting surface 10 is applicable are the very high frequency (VHF) band, the ultra-high frequency (UHF) band, the super high frequency (SHF) band, the tremendously high frequency (THF) band, and the extra high frequency (EHF) band. As described above, the alignment state of the liquid crystal molecules in the liquid crystal layer 106 changes depending on the voltage applied to the patch electrode 120. However, the alignment state of the liquid crystal molecules does not follow the frequency of the radio wave incident on the counter electrode 130. Due to such characteristics of the liquid crystal molecules, it is possible to change the dielectric constant of the liquid crystal layer 150 by the patch electrode 120 while scattering the radio wave at the counter electrode 130 and control the phase of the scattered wave.

### 3. Configurations of Reflecting Antenna Region 11 and Peripheral Region 12

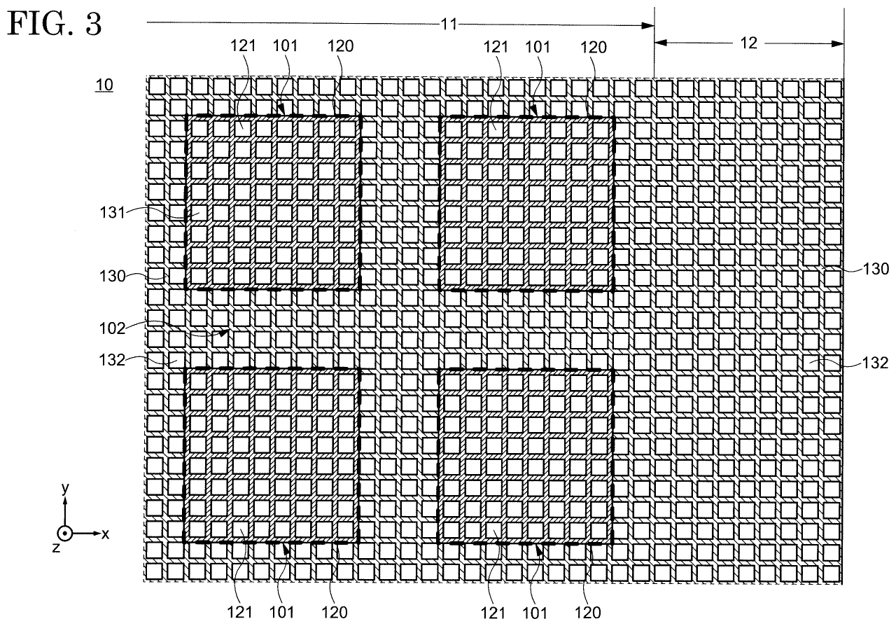

FIG. 3 is a schematic plan view showing configurations of the reflecting antenna region 11 and the peripheral region 12 of an intelligent reflecting surface 10 according to an embodiment of the present invention. Specifically, FIG. 3 is a partially enlarged view of a region A in FIG. 1B, which includes the four reflecting antenna cells 100, and the region A includes a part of the reflecting antenna region 11 and a part of the peripheral region 12.

In the reflecting antenna region 11, the intelligent reflecting surface 10 includes a first region 101 and a second region 102. The first region 101 is a region where the patch electrode 120 and the counter electrode 130 overlap each other in a plan view. That is, the first region 101 corresponds to the reflecting antenna cell 100. The second region 102 is a region where the patch electrode 120 and the counter electrode 130 do not overlap each other in a plan view. That is, the second region 102 is a region where only the counter electrode 130 is provided.

In the first region 101, the patch electrode 120 includes a plurality of first opening portions 121. Further, in the first region 101, the counter electrode 130 includes a plurality of second opening portions 131. Although the planar shape of each of the first opening portion 121 and the second opening portion 131 is rectangular, the cross-sectional shape is not limited thereto. The planar shape of the plurality of second opening portions 131 is substantially the same as the planar shape of the plurality of first opening portions 121. The second opening portion 131 has substantially the same opening area as the first opening portion 121 and overlaps the first opening portion 121. Therefore, in the first region 101, light can pass through the first opening portions 121 and the second opening portions 131.

In the second region 102, the counter electrode 130 includes a plurality of third opening portions 132. Although the planar shape of the third opening portion 132 is rectangular, the planar shape is not limited thereto. The planar shape of the plurality of third opening portions 132 is substantially the same as the planar shape of the plurality of second opening portions 131. In other words, the third opening portions 132 have substantially the same opening area as the second opening portions 131. Since no patch electrode 120 is provided in the second region 102, light can pass through the third opening portions 132 in the second region 102.

The peripheral region 12 has a configuration similar to that of the second region 102. That is, in the peripheral region 12, the counter electrode 130 includes a plurality of third opening portions 132. The counter electrode 130 in the second peripheral region 12 has substantially the same planar shape as the counter electrode 130 in the reflecting antenna region 11. Specifically, the counter electrode 130 in the peripheral region 12 has a grid shape. Since no patch electrodes are provided in the peripheral region 12, light can pass through the third opening portions 132 in the peripheral region 12.

The patch electrode 120 and the counter electrode 130 do not transmit light. However, in the intelligent reflecting surface 10, many opening portions (the plurality of first opening portions 121, the plurality of second opening portions 131, and the plurality of third opening portions 132) are provided in the patch electrode 120 and the counter electrode 130 to transmit light, and light incident on the intelligent reflecting surface 10 passes through the openings. Therefore, the intelligent reflecting surface 10 becomes a transparent intelligent reflecting surface.

When the reflecting device 1 is arranged by combining the plurality of intelligent reflecting surfaces 10, the peripheral regions 12 of the intelligent reflecting surfaces 10 are provided with counter electrodes 130 having substantially the same pattern shape as the counter electrodes 130 provided in the reflecting antenna region 11. Therefore, even when two intelligent reflecting surfaces 10 are adjacent to each other, the boundary between the two adjacent peripheral regions 12 is not easily noticeable. In other words, visibility at the boundary between intelligent reflecting surfaces 10 can be improved in the reflecting device 1 having transparency.

### <Modification 1 of First Embodiment>

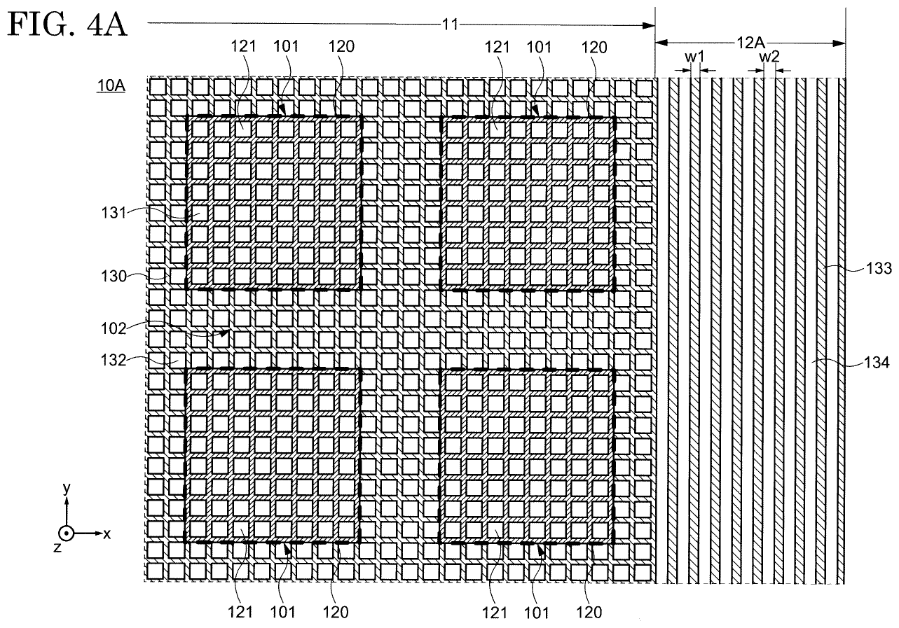

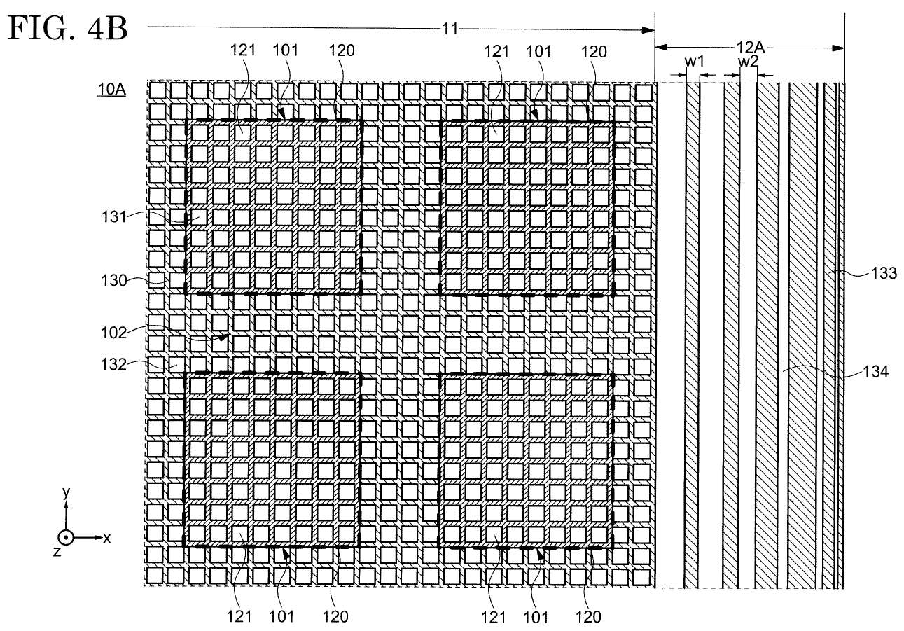

An intelligent reflecting surface 10A, which is the first modification of the intelligent reflecting surface 10, is described with reference to FIGS. 4A and 4B. In addition, hereinafter, when the intelligent reflecting surface 10A includes the same components as the intelligent reflecting surface 10, the description of those components may be omitted.

Each of FIGS. 4A and 4B is a schematic plan view showing configurations of the reflecting antenna region 11 and a peripheral region 12A of the intelligent reflecting surface 10A according to an embodiment of the present invention. Specifically, each of FIGS. 4A and 4B is an enlarged partial view of the region A in FIG. 1B, which includes the four reflecting antenna cells 100.

As shown in FIG. 4A, the peripheral region 12A includes a counter electrode 133 and a plurality of fourth opening portions 134. Specifically, the peripheral region 12A is provided with the counter electrode 133 formed from the same layer as the counter electrode 130. Further, the counter electrode 133 includes the plurality of fourth opening portions 134 extending in the y-axis direction (i.e., the direction along the edge surface of the intelligent reflecting surface 10A). In other words, the peripheral region 12A is provided with the counter electrode 133 having a linear shape different from the counter electrode 130 having a grid shape. The first width w1 of the linear shape of the counter electrode 133 may be the same as, smaller than, or larger than the second width w2 of the fourth opening 134. The first width w1 and the second width w2 may be determined by considering the aperture ratio of the counter electrode 130 in the reflecting antenna region 11 (hereinafter, may be simply referred to as “aperture ratio of the reflecting antenna region 11”). The aperture ratio of the reflecting antenna region 11 is represented by the opening area of the counter electrode 130 relative to the area of the reflecting antenna region 11. In other words, the aperture ratio of the reflecting antenna region 11 is represented by the sum of the opening areas of the second opening portions 131 and the third opening portions 132 relative to the area of the reflecting antenna region 11. On the other hand, the aperture ratio of the peripheral region 12 is represented by the opening area of the counter electrode 133 relative to the area of the peripheral region 12. In other words, the aperture ratio of the peripheral region 12 is represented by the opening areas of the fourth opening portions 134 relative to the area of the peripheral region 12. Therefore, for example, the first width w1 and the second width w2 may be determined such that the aperture ratio of the peripheral region 12 is approximately the same as the aperture ratio of the reflecting antenna region 11.

In addition, the counter electrode 133 in the peripheral region 12A is a dummy pattern, unlike the counter electrode 130 in the reflecting antenna region 11. Therefore, the counter electrode 133 does not need to be grounded and may be in a floating state.

Although the first width w1 and the second width w2 are provided at equal intervals in FIG. 4A, the second width w2 of the fourth opening 134 may vary. For example, as shown in FIG. 4B, the fourth opening 134 may be provided such that the second width w2 gradually decreases in the direction from the reflecting antenna region 11 toward the edge surface of the intelligent reflecting surface 10A. In this case, since the counter electrodes 133 are densely arranged in the vicinity of the boundary between the two intelligent reflecting surfaces 10A, the boundary between the two intelligent reflecting surfaces 10A is even less noticeable.

In addition, in the present modification, although the counter electrode 133 provided in the peripheral region 12A is described as having a linear shape, the planar shape of the counter electrode 133 provided in the peripheral region 12A is not limited thereto. Regardless of the shape of the counter electrode 133, the aperture ratio of the peripheral region 12A can substantially match the aperture ratio of the reflecting antenna region 11 by adjusting the size (area or width, etc.) of the counter electrode 133.

In the modification, although the reflecting device 1 has a configuration in which the plurality of intelligent reflecting surfaces 10A are combined and arranged, the counter electrode 133 in the peripheral region 12A of the intelligent reflecting surface 10A is provided to have a different planar shape from the counter electrode 130, so that the aperture ratio of the peripheral region 12A is approximately the same as the aperture ratio of the reflecting antenna region 11. Therefore, even when two intelligent reflecting surfaces 10A are adjacent to each other, the boundary between the two adjacent peripheral regions 12A is not easily noticeable. In other words, visibility at the boundary between intelligent reflecting surfaces 10A can be improved in the reflecting device 1 having transparency.

### <Modification 2 of First Embodiment>

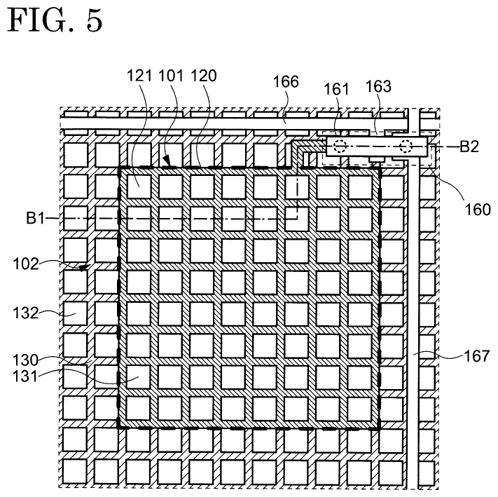

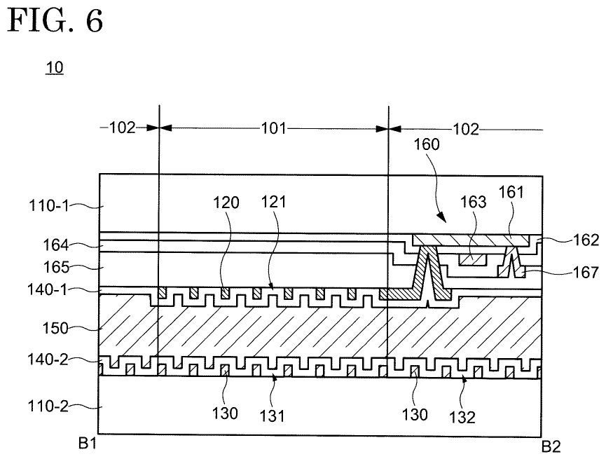

Not only the patch electrode 120 but also a switching element for controlling the potential supplied to the patch electrode 120 is provided on the first substrate 110-1. Here, the configuration of the reflecting antenna region 11 of the intelligent reflecting surface 10 is described in detail with reference to FIGS. 5 and 6.

FIG. 5 is a schematic plan view showing a configuration of the reflecting antenna region 11 of the intelligent reflecting surface 10 according to an embodiment of the present invention. FIG. 6 is a schematic cross-sectional view showing a configuration of the reflecting antenna region 11 of the intelligent reflecting surface 10 according to an embodiment of the present invention. Specifically, FIG. 6 is a cross-sectional view of the reflecting antenna region 11 cut along a line B1-B2 in FIG. 5. As described above, the first region 101 corresponds to the reflecting antenna cell 100.

FIGS. 5 and 6 show a transistor as an example of a switching element 160. Specifically, the switching element 160 includes a semiconductor layer 161, a gate insulating layer 162, and a gate electrode 163. The semiconductor layer 161 is provided on the first substrate 110-1. The gate insulating layer 162 is provided on the first substrate 110-1 so as to cover the semiconductor layer 161. The gate electrode 163 is provided on the gate insulating layer 162 so as to overlap the semiconductor layer 161. The gate electrode 163 is electrically connected to a selection signal line 166. An interlayer insulating layer 164 is provided on the gate electrode 163. The interlayer insulating layer 164 has two opening portions through which the semiconductor layer 161 is exposed. The semiconductor layer 161 is electrically connected to the patch electrode 120 through one opening portion and to a data signal line 167 through the other opening portion. A planarization layer 165 is provided on the interlayer insulating layer 164 and the data signal line 167. The patch electrode 120 is provided on the planarization layer 165.

The semiconductor layer 161 is formed using a silicon semiconductor such as amorphous silicon or polycrystalline silicon, or an oxide semiconductor such as indium gallium zinc oxide, indium gallium aluminum oxide, indium gallium oxide, zinc oxide, or gallium oxide. The gate insulating layer 162 and the interlayer insulating layer 164 are formed using, for example, a silicon oxide film, or a laminated structure of a silicon oxide film and a silicon nitride film. The gate electrode 163 and the selection signal line 166 may be formed in the same layer. The gate electrode 163 and the selection signal line 166 are formed using, for example, molybdenum (Mo), tungsten (W), or alloys thereof. The data signal line 167 is formed using a metal material such as titanium (Ti), aluminum (Al), or molybdenum (Mo). For example, the data signal line 167 is composed of a titanium (Ti)/aluminum (Al)/titanium (Ti) laminated structure, or a molybdenum (Mo)/aluminum (Al)/molybdenum (Mo) laminated structure. The planarization layer 165 is formed using a resin material such as acrylic or polyimide.

The selection signal line 166 and the data signal line 167 are electrically connected to the drive circuit 200. Control signals from the drive circuit 200 are input to the switching element 160 via the selection signal line 166 and the data signal line 167. The switching element 160 operates based on the control signals, thereby changing the alignment state of the liquid crystal molecules in the liquid crystal layer 150.

As described above, not only the patch electrode 120 but also the switching element 160 is provided on the first substrate 110-1. The metal material contained in the switching element 160 does not transmit light. Therefore, in the present modification, the aperture ratio of the reflecting antenna region 11 is determined by considering not only the light shielding by the counter electrode 130 but also the light shielding by the switching element 160, the selection signal line 166, and the data signal line 167. That is, in the present modification, the aperture ratio of the reflecting antenna region 11 is represented by the total opening area relative to the area of the reflecting antenna region 11. Here, the total opening area is the area of the region in which none of the patch electrode 120, the counter electrode 130, the switching element 160, the selection signal line 166, and the data signal line 167 are provided in a plan view. For example, in the present modification, the opening area of the third opening portions 132 in the peripheral region 12 may be adjusted so that the aperture ratio of the peripheral region 12 substantially matches the aperture ratio of the reflecting antenna region 11.

In the present modification, although the reflecting device 1 has a configuration in which the plurality of intelligent reflecting surfaces 10 are combined and arranged, the aperture ratio of the peripheral region 12 of the intelligent reflecting surface 10 is approximately the same as the aperture ratio of the reflecting antenna region 11. Therefore, even when the two intelligent reflecting surfaces 10 are adjacent, the boundary between the two adjacent peripheral regions 12 is not easily noticeable. In other words, in the reflecting device 1 having transparency, visibility at the boundary between intelligent reflecting surfaces 10B can be improved.

### Second Embodiment

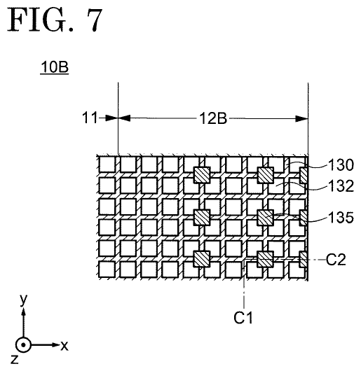

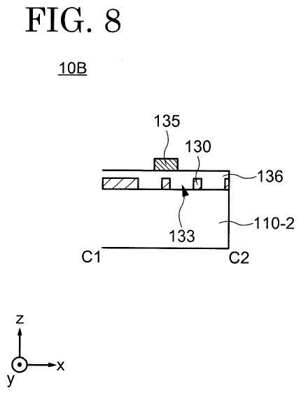

A reflecting device 1 and an intelligent reflecting surface 10B according to an embodiment of the present invention are described with reference to FIGS. 7 and 8. The reflecting surface 1 has a configuration in which a plurality of intelligent reflecting surfaces 10B are combined and arranged. In addition, hereinafter, when the intelligent reflecting surface 10A includes the same components as the intelligent reflecting surface 10, the description of those components may be omitted.

FIG. 7 is a schematic plan view showing a configuration of a peripheral region 12B of the intelligent reflecting surface 10B according to an embodiment of the present invention. FIG. 8 is a schematic cross-sectional view showing the configuration of the peripheral region 12B of the intelligent reflecting surface 10B according to an embodiment of the present invention. Specifically, FIG. 8 is a cross-sectional view of the peripheral region 12B cut along a line C1-C2 in FIG. 7. For convenience, the components on the first substrate 110-1 side and the liquid crystal layer 150, etc. are omitted in FIG. 8.

As shown in FIGS. 7 and 8, the peripheral region 12B of the intelligent reflecting surface 10B includes the counter electrode 130, the plurality of third opening portions 132, a plurality of dummy pattern electrodes 135, and an insulating layer 136. The insulating layer 136 is provided on a top of the counter electrode 130 so as to cover the counter electrode 130. The plurality of dummy pattern electrodes 135 are provided on a top of the insulating layer 136. That is, the plurality of dummy pattern electrodes 135 are provided on a different layer from the counter electrode 130.

The same metal material as the counter electrode 130 can be used for the dummy pattern electrode 135. The dummy pattern electrode 135 does not need to be grounded and may be in a floating state.

Although the planar shape of the dummy pattern electrode 135 shown in FIG. 7 is rectangular, the planar shape of the dummy pattern electrode 135 is not limited thereto. The planar shape of the dummy pattern electrode 135 may be circular. Further, the size of the dummy pattern electrode 135 is not limited to a certain value. For example, the area of the dummy pattern electrode 135 may be the same as the opening area of the third opening 132, or may be larger or smaller than the opening area of the third opening 132. Furthermore, the position in which the dummy pattern electrode 135 is placed is not limited to a certain position. The dummy pattern electrode 135 may be placed so as to overlap the counter electrode 130, or may be placed so as not to overlap the counter electrode 130.

In the present embodiment, the aperture ratio of the peripheral region 12B can be adjusted by adjusting the shape, size, and position of the dummy pattern electrode 135. Further, a similar configuration to the configuration in which the patch electrode 120 is spaced apart from the counter electrode 130 in the reflecting antenna region 11 can be formed in the peripheral region 12B by providing the dummy pattern electrode 135 spaced apart from the counter electrode 130. Therefore, the viewing angle dependence of the peripheral region 12B can be made closer to that of the viewing angle dependence of the reflecting antenna region 11. In this way, even when the two intelligent reflecting surfaces 10B are adjacent, the boundary between the two adjacent peripheral regions 12B is not easily noticeable. In other words, visibility at the boundary between the intelligent reflecting surfaces 10B can be improved in the reflecting device 1 having transparency.

In addition, although the above configuration in which the dummy pattern electrode 135 is provided on the second substrate 110-2 is described, a configuration in which the dummy pattern electrode 135 is provided on the first substrate 110-1 can also be applied in the present embodiment.

Embodiments and modifications of the present invention can be combined as appropriate as long as they do not contradict each other. Based on each embodiment, any addition, deletion or design change of configuration components, or any addition, omission or change of conditions of the process, made by a person skilled in the art as appropriate, is also included in the scope of the invention, as long as it has the gist of the invention.

It is understood that other advantageous effects different from the advantageous effects resulting from the mode of each embodiment disclosed above, but which are obvious from the description of the present specification or which can be easily foreseen by a person skilled in the art, are naturally brought about by the present invention.

What is claimed is:

1. An intelligent reflecting surface, comprising:
a patch electrode over a first substrate;
a counter electrode over a second substrate different from the first substrate;
a liquid crystal layer between the patch electrode and the counter electrode;
a reflecting antenna region in which the patch electrode and the counter electrode overlap each other in a plan view; and
a peripheral region in which only the counter electrode is provided, surrounding the reflecting antenna region in the plan view,
wherein each of the patch electrode and the counter electrode comprises a plurality of opening portions.

2. The intelligent reflecting surface according to claim 1, wherein the plurality of opening portions of the counter electrode in the peripheral region has substantially a same planar shape as the plurality of openings of the counter electrode in the reflecting antenna region.

3. The intelligent reflecting surface according to claim 1, wherein an aperture ratio of the peripheral region is substantially a same as an aperture ratio of the reflecting antenna area.

4. The intelligent reflecting surface according to claim 1, wherein the counter electrode in the peripheral region has a lattice shape.

5. The intelligent reflecting surface according to claim 1, wherein the counter electrode in the peripheral region has a linear shape.

6. The intelligent reflecting surface according to claim 1, wherein a dummy pattern electrode is provided in the peripheral region as a layer different from the counter electrode.

7. A reflecting device, comprising:
a first intelligent reflecting surface; and
a second intelligent reflecting surface,
wherein each of the first intelligent reflecting surface and the second intelligent reflecting surface comprises:
a patch electrode over a first substrate;
a counter electrode over a second substrate different from the first substrate;
a liquid crystal layer between the patch electrode and the counter electrode;
a reflecting antenna region in which the patch electrode and the counter electrode overlap each other in a plan view; and
a peripheral region in which only the counter electrode is provided, surrounding the reflecting antenna region in the plan view,
wherein each of the patch electrode and the counter electrode comprises a plurality of opening portions, and
wherein the peripheral region in the first intelligent surface and the peripheral region in the second intelligent surface are in contact with each other.

8. The reflecting device according to claim 7, wherein in each of the first intelligent surface and the second intelligent surface, the plurality of opening portions of the counter electrode in the peripheral region has substantially a same planar shape as the plurality of openings of the counter electrode in the reflecting antenna region.

9. The reflecting device according to claim 7, wherein in each of the first intelligent surface and the second intelligent surface, an aperture ratio of the peripheral region is substantially a same as an aperture ratio of the reflecting antenna area.

10. The reflecting device according to claim 7, wherein in each of the first intelligent surface and the second intelligent surface, the counter electrode in the peripheral region has a lattice shape.

11. The reflecting device according to claim 7, wherein in each of the first intelligent surface and the second intelligent surface, the counter electrode in the peripheral region has a linear shape.

12. The reflecting device according to claim 7, wherein in each of the first intelligent surface and the second intelligent surface, a dummy pattern electrode is provided in the peripheral region as a layer different from the counter electrode.
